(19) United States
(12) Patent Application Publication
(10) Pub. No.: US 2021/0401026 A1
(43) Pub. Date: Dec. 30, 2021

(54) NUT-CRACKING APPARATUS

(71) Applicant: South Georgia Pecan Company, Inc., Valdosta, GA (US)

(72) Inventors: Jeffrey Jinnin Worn, Valdosta, GA (US); John Mitchell, Valdosta, GA (US)

(73) Assignee: South Georgia Pecan Company, Inc., Valdosta, GA (US)

(21) Appl. No.: 17/355,403

(22) Filed: Jun. 23, 2021

Related U.S. Application Data
(60) Provisional application No. 63/044,348, filed on Jun. 25, 2020.

(51) Int. Cl. A23N 5/00

(52) U.S. Cl. CPC A23N 5/00

(57) ABSTRACT

Improved nut-cracking apparatus enables a user to set the gap and/or taper of opposing cracking plates in real time during machine operating to achieve superior, repeatable results cracking various nuts, including different varieties of pecan. To independently adjust both gap and taper, the lower portion of the rear cracking plate is hinged to adjust taper, and the hinged rear plate is further coupled to a slide plate, enabling the overall gap to be adjusted with a mechanism that causes the slide plate to move toward and away from the gap without changing the angle of the rear plate. The stroke of the reciprocating front plate may also be adjustable. The apparatus may further include visual indicators that convey the settings of the overall gap or gap taper so that multiple machines may be brought on line or adjusted without excessive trial and error.

### REFERENCE TO RELATED APPLICATIONS

This application claims priority to, and the benefit of, U.S. Provisional Patent Application Ser. No. 63/044,348, filed Jun. 25, 2020, the entire content of which is incorporated herein by reference.

### FIELD OF THE INVENTION

This invention relates generally to nut-cracking machines and, in particular, to nut-cracking machines with improved reliability, performance and user-adjustment capabilities.

### BACKGROUND OF THE INVENTION

There have been numerous machines and techniques used to crack nuts. The idea to use a reciprocating plate to crack nuts against a stationary plate is more than 100 years old. U.S. Pat. No. 2,339,596, NUT CRACKING MACHINE states that “[i]t is common in the art of cracking of nuts that there be two opposed surfaces, one of which may be rigid and the other of which may be movable, to crack nuts therebetween.” As seen in FIG. 1, the improvement in this case is curved plates. “The arcuate or curved lower portions of the members 9 and 15, being positioned relatively opposite and tending to direct the nuts from a relatively vertical position toward a somewhat horizontal position, cause positive cracking of the nuts when they arrive at a pre-determined position between the plates 9 and 15 and overcome the shifting movement of the nuts. It has been found, too, that the curvature at the lower ends of the members 9 and 15, which in effect form a receiving trough for the nuts, causes definite cracking of the shells but overcomes all injury to the nut meats.”

U.S. Pat. No. 1,243,572, NUT OPENING MACHINE, illustrated in FIG. 2, also teaches opposing, cyclically driven, tapered cracking plates 12, 13. In this machine, the nuts are fed by means of a slide likewise actuated by a cam-wheel and a lever. A jaw with a vertical pressure surface is reciprocated by means of a lever which at one end slides on a camwheel, while the other jaw, which makes a small angle with the vertical, is arranged stationarily. The improvement in this case is that the nuts come between the jaws when the movable jaw moves a little backward. “Hereupon the jaw moves forward, opens the nut and now moves backward a greater-distance, in order that the cracked nut shall be able to fall down between the jaws. . . . The breaking of the shell is completed as soon as the eccentric is in the position in FIG. [2]. Directly after this, the roller 26 passes into the depression in the cam-wheel, whereby the jaw 13 is released from the cam 33 and swings back by reason of its own weight (or by a spring), so that the broken nut falls through the hopper 34 into the channel 35. The opening of the jaws however lasts at the most or a quarter of a revolution so that before the following nut falls between the jaws the latter are again closed.”

U.S. Pat. No. 5,501,123, NUT CRACKING APPARATUS (FIG. 3) also teaches first and second opposed cracking plates (20). A nut is shown at 52. In this case the plates pivot from above, and the machine has “a reciprocal drive mechanism that swings the plates together to a cracking position where the plates are closer together and then to a release position where the release mechanism moves the plates apart releasing the cracked nuts;” ('123 Patent, Abstract)

While machines such as those mentioned above prove effective in some circumstances, there remains an outstanding need for a nut-cracking machine with improved reliability, performance and adjustment capabilities. Ideally, such an improved machine should afford the ability to perform certain adjustments while the machine is operating to reduce down time and enhance throughput.

### BRIEF DESCRIPTION OF THE DRAWINGS

FIG. 1 is a drawing of prior-art nut cracking apparatus including curved plates;

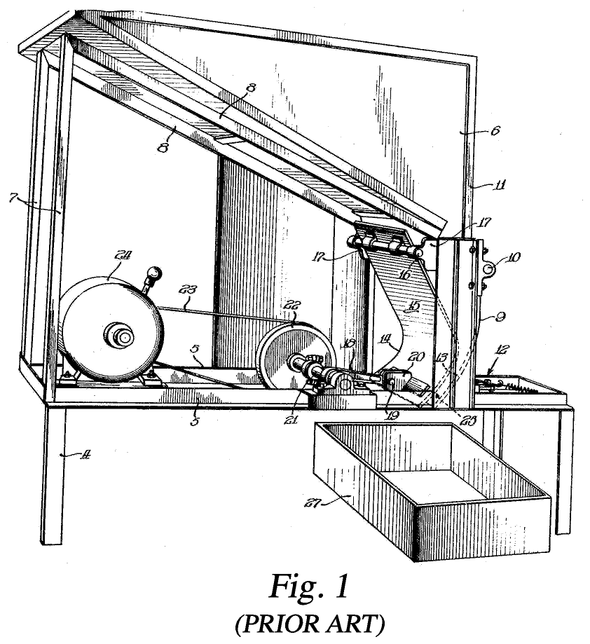

FIG. 2 is a drawing of a different prior-art nut cracking apparatus wherein nuts are delivered to a cracking zone when a movable jaw moves slightly backwards;

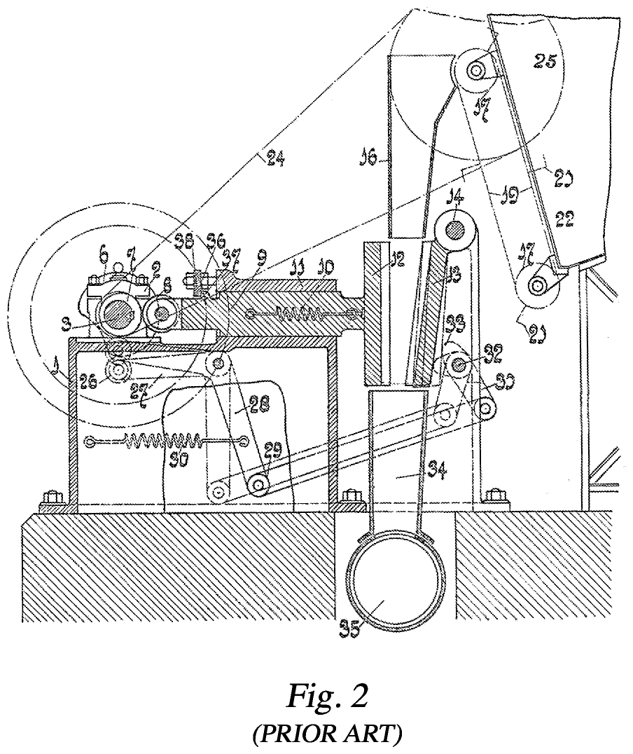

FIG. 3 is a drawing of a further prior-art nut cracking apparatus wherein a release mechanism moves the plates apart so as to release the cracked nuts;

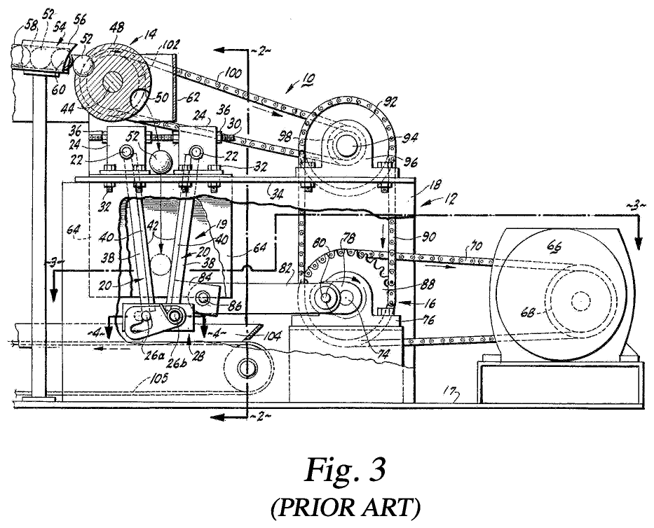

FIG. 4 depicts a preferred embodiment of the invention seen from a first perspective;

FIG. 5 illustrates the preferred embodiment from a different perspective; and

FIG. 6 is a simplified, not-to-scale rendering that shows adjustment procedures during operation of the machine.

### SUMMARY OF THE INVENTION

This invention is directed to improved nut-cracking apparatus and, in particular, to improved opposing plate nut-cracking apparatus. More specifically, it has been discovered that to achieve superior repeatable results, the gap and/or taper of the opposing plates must be set very precisely. Importantly, such adjustments should also be made while the machine is in operation so that the results can be monitored in real time, providing immediate feedback to optimize gap characteristics.

An improved nut cracker constructed in accordance with the invention includes front and rear cracking plates having opposing inner surfaces, outer surfaces, and upper and lower edges. The upper edges of the plates are spaced apart at a distance greater than the lower edges, such that a tapered gap is established between the inner surfaces of the front and rear plates. A motor is coupled to the front cracking plate, causing the front cracking plate to reciprocate toward and away from the rear cracking plate so as to crack nuts fed into the gap. In contrast to existing machines, the disposition of the rear cracking plate is user adjustable to set the overall gap, the taper of the gap, or both the overall gap and the taper while the front cracking plate is reciprocating. The apparatus may further include a visual indicators that convey the settings of the overall gap or gap taper.

In the preferred embodiment, the lower edge of the rear cracking plate is hinged, and the taper of the gap is adjusted with a mechanism that changes the angle of the rear cracking plate. The mechanism that changes the angle of the rear cracking plate may for example include a threaded rod having a first end coupled to the back surface of the rear cracking plate and a second end coupled to a user-rotatable knob, such that as the knob is turned, the angle of the rear cracking plate is changed.

The apparatus includes a base plate, and the rear cracking plate may be hinged to the base plate if the overall gap is not adjustable. To independently adjust both gap and taper, however, the rear cracking plate may be hinged to a slide plate, enabling the overall gap to be adjusted with a mechanism that causes the slide plate to move toward and away from the gap without changing the angle of the rear plate. The gap adjustment mechanism may for example include a second threaded rod having a first end coupled to the slide plate and a second end coupled to a different user-rotatable knob.

The motor may be coupled to the front cracking plate through a link arm connected to a rotating cylinder to establish a stroke, and the rotating cylinder may include a plurality of link-arm attachment points to adjust the stroke of the link arm and the front cracking plate. The apparatus may further include a nut infeed chute to receive and direct nuts into the gap, and the nut infeed chute may be adjustable in multiple dimensions. The apparatus may additionally include an air knife to urge nuts into and through the gap and past an opening in a base plate.

The front and rear cracking plates may extend upwardly from a base plate, with the front cracking plate being vertical and perpendicular to the base plate or tilted slightly, adding to the taper of the gap. One or both of the front and rear cracking plates may be multilayed or composite cracking plates including a backing and working layers made from any suitably rigid materials such as metal or ceramic. In the preferred embodiments one or both of the front and rear cracking plates have flat inner surfaces, and the cracking region between the front and rear cracking plates exhibits a distance in the range or 0.5 to 1 inch or more to crack different varieties of pecans.

### DETAIL ED DESCRIPTION OF THE INVENTION

This invention improves upon the prior art by providing a nut-cracking apparatus with features that enhance performance, reliability, and adjustment capability. Although the embodiments described herein are ideally suited to the cracking of pecans, the machine may be modified for other type of nuts through appropriate engineering modification.

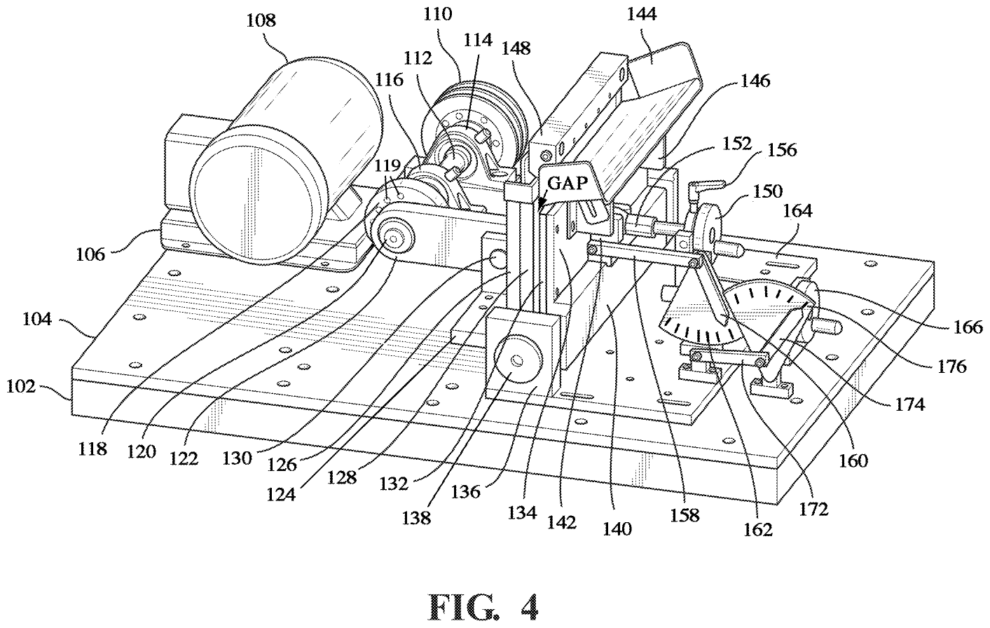

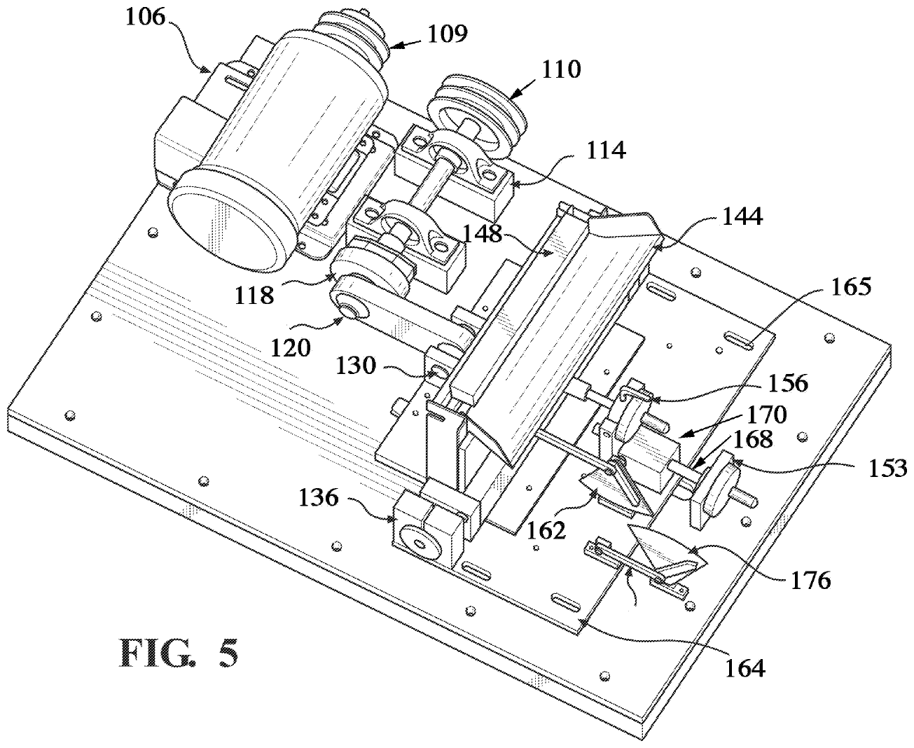

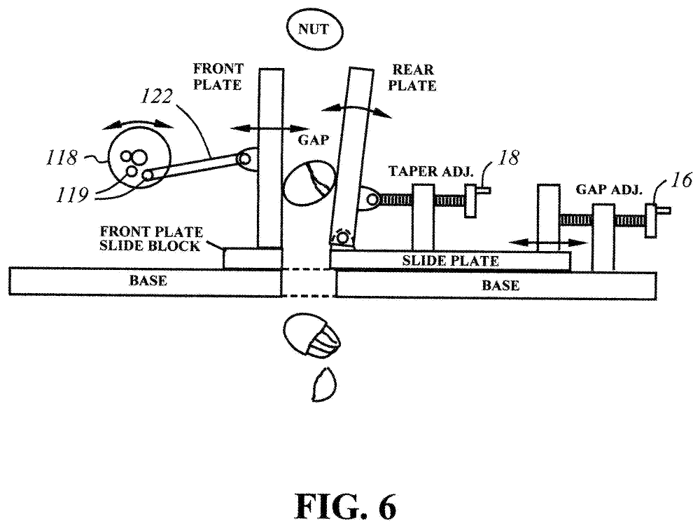

FIG. 4 is an illustration of a preferred embodiment from a first perspective, FIG. 5 is an illustration from a different perspective, and FIG. 6 is a detail diagram showing operation and adjustments.

Functional components are coupled to a frame base 102 constructed of any rigid stable material such as metal, preferably steel or aluminum. While components may be mounted to base 102 directly, an intervening table-top adjustment plate 104 may be provided for more versatile mounting arrangements. A motor mount 106 is attached to the base, and an electric motor 108 is mounted to 106. Motor 108 drives a first pulley 109 which, in turn, rotates a second pulley 110 through one or more V-belts (not shown). Pulley 110 is connected to a rotating shaft 112 held in position by a set of bearing blocks 114, 116. The bearing mount brackets are made from solid metal to avoid breakage, and the blocks and bearings are pinned for easy assembly and to prevent misalignment during use.

While motor 108 could be arranged to drive shaft 112 directly, the use of pulleys and belts (or chains, etc.) provides for performance adjustments and eases maintenance. Indeed, the motor mount facilitates belt tensioning relative to the base, enabling the belt to be adjusted by turning a single bolt, requiring only one person.

Shaft 112 is coupled to rotating cylinder 118. One end of a link arm 122 is eccentrically coupled to the cam 118 at 120, and the other end of link arm 122 is coupled to a laterally reciprocating block 124 through coupling 130. Block 124 is coupled to the front cracking plate, such that as the motor turns the pulleys and shaft 112, the link arm 122 and block 124 reciprocates, causing the front cracking plate to toward and away from a rear cracking plate with an opening and closing tapered gap therebetween. The front cracking plate typically remains generally vertical as it moves back and forth, though a desired degree of consistent taper may also be provided.

Cylinder 108 preferably includes a series of holes 109 around the cylinder, offset by a predetermined amount such as 1/2 mm, thereby providing stroke adjustment within a predetermined range such as from 2 to 10 mm, or thereabouts. That is, rotating one set of holes will add or subtract exactly 1 mm to or from the stroke. The cylinder 108 may be marked with numbers for each set of holes that represent the stroke adjustment.

While singular front and rear cracking plates may be used, it has been determined that composite plates are preferred, comprising backing plates with working surfaces that may be removed and replaced due to wear. Thus, in a preferred embodiment, the front cracking plate actually comprises a backing/working assembly 126/128, and the rear cracking plate comprises a backing/working assembly 132/134.

Nuts to be cracked are fed into the gap between the front and rear cracking plate assemblies through an infeed chute 144. The infeed chute 144 may be adjusted via bracket 146, allowing for adjustment up/down, forward/back and angular. The location of the front of the chute as compared to the rear cracking plate may be maintained through all adjustments. A T-nut (not visible) on each side of the bracket is used to lock the chute in place, which allows for a free hand to hold the chute in place while tightening the locking bolts.

An optional air knife 148 may be arranged so as to blow air into the gap and urge nuts to proceed through the cracking mechanism. The air knife preferably spans the width of the cracking plates with equal amounts of air, thereby forcing the nuts through the cracking plates faster. This also helps keep the plates clean, which reduces the need to shut down for cleaning. Once cracked, the nuts fall through the bottom of the apparatus, through slots 165 in the base layer(s) as shown in FIG. 5.

The rear cracking plate is independently adjustable in multiple dimensions to achieve a precise, repeatable cracking process. In particular, rear plate assembly may be adjusted to alter the taper of the gap while, at the same time, the overall gap itself may also be precisely adjusted independently of taper. These adjustments will now be explained in detail.

The rear cracking plate assembly is coupled to block 140, which in turn is pivotably coupled to opposing pivot mounting blocks 136. A rod 152 is coupled at one end to the back side of the rear cracking plate assembly, with the other end being attached to a rotatable knob 150. A portion of rod 152 is threaded through a block 153 having a threaded bore, such that as knob 150 is turned, the taper angle between the front and rear cracking plate assemblies is precisely adjusted. A link member 158 is also pivotably coupled to the back side of the rear cracking plate assembly and further coupled to pointer 160. Pointer 160 is positioned relative to an indicator plate with markings 162 that show precisely where the taper angle has been set.

The above-described taper-angle adjustment mechanism and indicator may be mounted directly to a stationary base plate if overall gap is non-adjustable. However, in the preferred embodiment, to facilitate independent, real-time adjustment of both taper angle and overall gap spacing, the taper-angle adjustment mechanism and indicator are mounted on a slide plate 164, which is coupled to base plate(s) with threaded fasteners (not shown) that extend through slots, enabling the slide plate to move laterally toward and away from the gap. This provides for adjustment of the overall gap between the rear cracking plate(s) relative to the front cracking plate(s) regardless of the setting of the taper adjustment mechanism.

The gap adjustment mechanism includes a second rotatable knob 166 coupled to a rod 170 extending from a block 170 mounted on slide plate 164. As such, when knob 166 is rotated, the overall gap spacing is adjusted independently of the taper established through knob 150. Similar to the taper adjustment mechanism, an indicator assembly is preferably provided, including a rod 172 coupled to pointer arm 174 that shows precisely where the gap has been set relative to markings on a second indicator plate 176.

In preferred embodiments, link member 158 is parallel to, and in the same plane as, rod 152, and link member 172 is parallel to, and in the same plane as, rod 168 so that the respective pointers accurately reflect the actual taper and gap settings. Note that either or both of the knobs 150, 166 may further include locking levers such as 156 to maintain the taper and gap settings despite vibration experienced during operation.

Note that the use of threaded rods and rotatable knobs are not the only technique that may be used to adjust the disposition of the rear cracking plate. For example, user-operable levers with link arms coupled to the rear plate and/or slide plate may alternatively be used. Likewise, the indicators may also be implemented differently. For example, as opposed to separate gages with pointers, a plate with markings may be mounted relative to an outer edge of the rear plate to convey plate angle, and markings may be made on or in a base plate to indicate the position of the slide plate.

FIG. 6 is a detail diagram showing operation and adjustments. FIG. 6 is not to scale, and the taper and gap indicators are not shown for purposes of clarity. During setup, a hole 119 in cylinder 118 is selected to set the stroke of arm 122, with gap and taper being set to anticipated values based upon factors such as nut size. Nuts are fed into the gap from a conveyor, for example, at a rate to achieve a desired throughput without overloading the apparatus. The front plate (or composite plate assembly) translates toward and away from the rear plate (or composite plate assembly) with a cycle time in the range of a second, more or less. The front plate may be substantially vertically oriented or with the top of the plate tilted away form the gap at a small angle.

The region in the gap where cracking takes place is typically adjusted to be in the range of one-half inch to one inch or more depending upon size, variety, etc. While parts of the shell may come off the nut during cracking this is not necessary, and the cracked nuts are typically fed to a shelling machine responsible for shell removal. If the nuts are heated prior to cracking for pasteurization, for example, it has been found that allowing the nuts to enter the cracker in a still-warm state improves cracking success.

The results of the process are monitored, with gap and taper being adjusted until desired results are achieved. The ability to adjust gap and taper during the cracking process is particularly advantageous, and the provision of indicators associated with the gap and taper settings allows other machines operating in parallel to be set to desired parameters with limited trial-and-error. Guarding (not shown) may be added to totally enclose all moving parts.s

The gap adjustment assembly has minimal play, so the gap can be adjusted accurately, and dowel pins on the gap adjustment plate keep the cracker plates accurately aligned at all times. The taper gage is preferably marked with easily read numbers to reflect the actual taper. Note that adjusting the stroke using the holes 119 on cylinder 118 changes the accuracy of the gap adjustment gage. As such, each time the stroke is changed, the linkage should be changed to bring the gage back to the proper calibration. Accordingly, different linkages may be provided for each stroke adjustment. Such linkages may be marked (i.e., with a number) that corresponds to the stroke setting, thereby making it easier to determine the correct linkage to use for each setting.

1. Improved nut-cracking apparatus, comprising:
front and rear cracking plates having opposing inner surfaces, outer surfaces, and upper and lower edges;
wherein the upper edges of the plates are spaced apart at a distance greater than the lower edges, such that a tapered gap is established between the inner surfaces of the front and rear plates;
a motor coupled to the front cracking plate causing the front cracking plate to reciprocate toward and away from the rear cracking plate to crack nuts fed into the gap; and
wherein the rear cracking plate is user adjustable to set the overall gap, the taper of the gap, or both the overall gap and the taper while the front cracking plate is reciprocating.

2. The apparatus of claim 1, wherein the lower edge of the rear cracking plate is hinged, and the taper of the gap is adjusted with a mechanism that changes the angle of the rear cracking plate.

3. The apparatus of claim 2, wherein the mechanism that changes the angle of the rear cracking plate includes a threaded rod having a first end coupled to the back surface of the rear cracking plate and a second end coupled to a user-rotatable knob.

4. The apparatus of claim 1, further including a visual indicator that indicates the setting of the overall gap.

5. The apparatus of claim 1, further including a visual indicator that indicates the setting of the taper of the gap.

6. The apparatus of claim 1, wherein the rear cracking plate is coupled to a slide plate, and the overall gap is adjusted with a mechanism that causes the slide plate to move toward and away from the gap without changing the angle of the rear plate.

7. The apparatus of claim 6, wherein the mechanism that causes the slide plate to move toward and away from the gap includes a threaded rod having a first end coupled to the slide plate and a second end coupled to a user-rotatable knob.

8. The apparatus of claim 6, wherein the lower edge of the rear cracking plate is hinged to the slide plate, and the taper of the gap is adjusted with a mechanism that changes the angle of the rear cracking plate.

9. The apparatus of claim 8, wherein the mechanism that changes the angle of the rear cracking plate includes a threaded rod having a first end coupled to the back surface of the rear cracking plate and a second end coupled to a user-rotatable knob.

10. The apparatus of claim 1, wherein the motor is coupled to the front cracking plate through a link arm coupled to a rotating cylinder to establish a stroke, and the rotating cylinder includes a plurality of link-arm attachment points to adjust the stroke of the link arm.

11. The apparatus of claim 1, further including an adjustable nut infeed chute to receive and direct nuts into the gap.

12. The apparatus of claim 1, further including an air knife to urge nuts into and through the gap.

13. The apparatus of claim 1, wherein the front and rear cracking plates extending upwardly from a base plate, and wherein the base plate includes an opening through which the cracked nuts fall.

14. The apparatus of claim 13, wherein the front cracking plate is vertical and perpendicular to the base plate.

15. The apparatus of claim 1, wherein the upper edge of the front cracking plate is tilted away from the gap, thereby increasing the taper of the gap.

16. The apparatus of claim 1, wherein one or both of the front and rear cracking plates are layered cracking plates including a backing layer and a working layer.

17. The apparatus of claim 1, wherein one or both of the front and rear cracking plates have flat inner surfaces.

18. The apparatus of claim 1, wherein:
the lower edge of the rear cracking plate is hinged to a slide plate;
the angle of the rear cracking plate is user adjustable to set the taper of the gap; and
the position of the slide plate is user adjustable to set the gap.

19. The apparatus of claim 1, wherein the gap includes a cracking region between the front and rear cracking plates having a distance in the range or 0.5 to 1 inch.

20. The apparatus of claim 1, wherein the nuts fed into the gap are pecans.
